(19) United States
(12) Patent Application Publication
(10) Pub. No.: US 2005/0160637 A1
(43) Pub. Date: Jul. 28, 2005

(54) Luminescent objects

(76) Inventor: Anthony Hesse, Toms River, NJ (US)

Correspondence Address: BROWN & MICHAELS, PC;400 M & T BANK BUILDING, 118 NORTH TIOGA ST, ITHACA, NY, 14850, US

(21) Appl. No.: 10/834,387

(22) Filed: Apr. 29, 2004

Related U.S. Application Data
(60) Provisional application No. 60/466,266, filed on Apr. 29, 2003.

(51) Int. Cl. G09F 19/00

(52) U.S. Cl. 40/124.5

(57) ABSTRACT

A process for making a luminescent cemetery marker by applying a luminescent material to a cemetery marker is disclosed. The process can use luminescent material that is non-toxic and contains a luminescent pigment. The luminescent pigment can include a silicate aluminate.

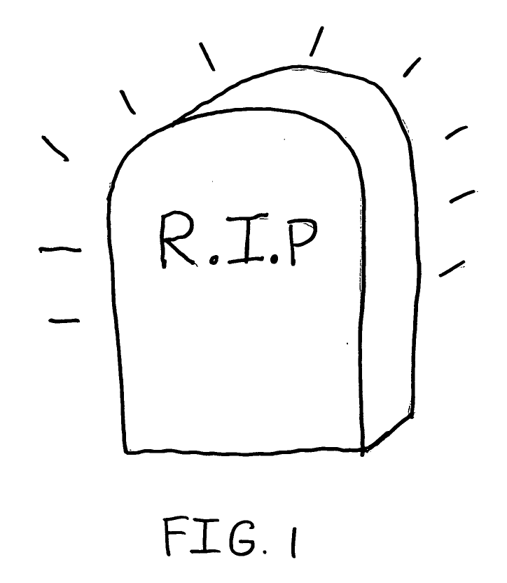

This application claims priority to Provisional Application No. 60/466,266 filed Apr. 29, 2003, the specification of which is incorporated herein in its entirety.

### DETAILED DESCRIPTION OF THE INVENTION

According to one embodiment of the present invention, a process is disclosed for making a luminescent cemetery marker comprising applying a luminescent material to a cemetery marker. The luminescent material is preferably non-toxic, although the use of toxic materials is not precluded. The cemetery marker may be comprised of granite, marble, sandstone, brass, slate, glass, metal, wood, ceramics, plastic or fiberglass, for example. Also, cemetery marker may include any type of grave marker including, grave stones, head stones, grave alignment stones, figurines (e.g., crosses, angels and candles), or any other type of article found at a grave site.

The luminescent material comprises a medium and a luminescent pigment. The type of medium will depend on the material from which the cemetery marker is made and also the type of luminescent pigment used. Examples of the types of media that may be employed include paints, glazes and other coatings. The media employed should have good adhesion to the cemetery marker. Glazes, for example, are preferably employed where the cemetery marker is comprised of a ceramic material. Also, the media employed should be compatible with the type of pigment used, i.e., if the pigment is not water resistant, water-based media are preferably not used. Preferably the medium is clear or a light color so as to not hide the luminescent effect of the pigment.

Coatings employed in the present invention may include a variety of different types of coatings, including paints, glazes, enamels, or other types of coatings. One preferred embodiment includes a paint or coating comprised of a clear organic resin (e.g., clear epoxy urethane or an acrylic resin) and organic solvents to which the luminescent pigment is added. Preferably the organic resin is neutral or weakly acidic, and includes such resins as polyurethane resin, acrylic acid resin, epoxy resin, and polyester resin, for example. Preferably the resins have a high viscosity or anti-settling agents to prevent settling of the pigments. The paint, coating, or glaze may also include suitable bonding agents or other chemicals known to those of ordinary skill in the art to provide for proper adhesion. Further, the media may contain dyes or coloring agents to achieve any desired color.

The luminescent pigment may include, for example, alkaline earth aluminate phosphors, zinc sulfides, such as ZnS:Cu, silicate aluminates, strontium aluminate (SrAlO3:Eu), or combinations thereof. These pigments work by absorbing and releasing light energy, in a continuing cycle. When the surroundings are bright, they absorb light energy and release this light energy when it is dark. The pigments are rechargeable many times over simply by exposing them to any light source, especially UV light. Suppliers from which these pigments may be purchased include Pete's Luminous Creations of Singapore and Extreme Glow of Tupelo, Miss. Various particle sizes, mesh sizes and grades of the pigments may be used depending on the desired effect. Sizes ranging from 10-70 um particle size and 200 to 500 mesh size, for example, are preferably employed. The larger the particle size, the higher the intensity of luminescence. Particle sizes of about 45-65 um, 200 mesh, are generally suitable for brush painting and dipping. Particle sizes of about 10-40 um, 300-400 mesh, are generally suitable for spray painting and plastic molding. Glow time and intensity are generally dependent on type of pigment, particle size and grade. Alkaline earth aluminate phosphors and silicate aluminates have longer glow times than ZnS:Cu, for example. The pigment may be added to the media in an amount effective to produce a luminescent effect. Color dyes may also be added to the pigments to achieve various luminescent colors.

The luminescent materials containing the luminescent pigments may be applied in a variety of ways. Paints or coatings may be dipped, brushed, rolled or sprayed onto the markers, for example. Glazes may be applied by painting, pouring or firing, for example.

The life span of the luminescent material applied to or employed in the cemetery marker can have a life span of a year or more, depending on the pigment employed and the environment to which the luminescent material is subjected. To increase the life span of the luminescent material, additional protections may be employed, such as the application of a spray fixative, e.g., a plastic spray fixative, or an epoxy protector, e.g., a glass epoxy protector. The epoxy protector is a preferred choice for outdoor environments. Preferably, it employs an epoxy and a hardener which are added in sufficient amounts to form a hard, scratch-proof protective coating.

According to another embodiment of the present invention, a process is disclosed for making a luminescent cemetery marker comprising forming a cemetery marker from a polymer material, wherein the polymer material contains a luminescent material. Preferably the luminescent material is non-toxic. The polymer material containing the luminescent material may be formed into any desired shape, including flat plates or figurines, for example.

The polymer material may include plastic or rubber materials such as, for example, rubber, styrenics, polyolefin, plastisol, PVC, acrylics, polyurethane, polyacrylates, polycarbonate, polypropylene, polyamides, polymethacylics, polycyanoethylenes, polyacrylonitrides, polyphenylene oxide, polyimide, ethylenevinylchloride, polyvinylacetate, acrylonitrile rubber, melamine, polyethylene, polystyrene, polyesters, or combinations thereof. In addition to the polymer material and luminescent material, the cemetery marker may also include silicone (a releasing agent), mineral oil (to improve injection molding flow and/or adhesion to other additives, for example), a foaming agent or filler, dyes or coloring agents, polymerization catalysts, UV stabilizers, cure accelerators, and leveling agents, for example.

The luminescent pigment may include, for example, alkaline earth aluminate phosphors, zinc sulfides, such as ZnS:Cu, silicate aluminates, strontium aluminate (SrAlO3:Eu) and combinations thereof. Various particle amounts, particle sizes, mesh sizes and grades of the pigments may be used depending on the desired effect. Alkaline earth aluminate phosphors and silicate aluminates have longer glow times than ZnS:Cu, for example. The pigment should be added to the media in an amount effective to produce a luminescent effect.

The cemetery marker formed of the polymer material having a luminescent material may be formed by any process known to one of ordinary skill in the art including injection molding, blow molding, plastisol molding, or extrusion, for example.

According to another embodiment of the present invention, a luminescent cemetery marker is disclosed comprising a cemetery marker and a luminescent material coating. The luminescent material coating may be a paint ,a glaze, or an enamel, for example, containing luminescent pigments. The luminescent pigments may include, for example, alkaline earth aluminate phosphors, zinc sulfides, such as ZnS:Cu, silicate aluminates, strontium aluminate (SrAlO3:Eu) and combinations thereof. A preferred pigment is a silicate aluminate. According to an alternative embodiment, the luminescent cemetery marker includes a painted cemetery marker and a luminescent coating. Thus, in this embodiment the coating containing the luminescent material may be applied to a cemetery marker already having a non-luminescent coating or paint applied.

According to another embodiment, a luminescent cemetery marker is disclosed comprising a cemetery marker comprised of a polymer material including a luminescent pigment. The luminescent pigments may include, for example, alkaline earth aluminate phosphors, zinc sulfides, such as ZnS:Cu, silicate aluminates, strontium aluminate (SrAlO3:Eu) and combinations thereof. A preferred pigment is a silicate aluminate. The polymer material may include plastic or rubber materials such as, for example, rubber, styrenics, polyolefin, plastisol, PVC, acrylics, polyurethane, polyacrylates, polycarbonate, polypropylene, polyamides, polymethacylics, polycyanoethylenes, polyacrylonitrides, polyphenylene oxide, polyimide, ethylenevinylchloride, polyvinylacetate, acrylonitrile rubber, melamine, polyethylene, polystyrene, polyesters, or combinations thereof.

According to another embodiment of the present invention, a process is disclosed for making luminescent children's play equipment or safety surfaces comprising forming the play equipment or surface of a material comprised of a polymer material and a luminescent pigment. Preferably the luminescent material is non-toxic. The play equipment or surface may include, for example, furniture, including tables, chairs, and beds, jungle gym equipment such as slides, teeter totters, and swings, diving boards, surface materials available for playgrounds, volleyball courts, and around pools, for example.

The polymer material may include any plastic or rubber material that can be molded, such as, for example, rubber, styrenics, polyolefin, plastisol, PVC, acrylics, polyurethane, polyacrylates, polycarbonate, polypropylene, polyamides, polymethacylics, polycyanoethylenes, polyacrylonitrides, polyphenylene oxide, polyimide, ethylenevinylchloride, polyvinylacetate, acrylonitrile rubber, melamine, polyethylene, polystyrene, polyesters, and combinations thereof. The polymer used can be varied depending on the equipment being produced and its end use. Preferably, the polymer material can be injection molded, extruded, blow molded, plastisol molded or similarly shaped into a desired form. In addition to the polymer material and luminescent material, the luminescent children's play equipment and safety surfaces may also include silicone (a releasing agent), mineral oil (to improve injection molding flow and/or adhesion to other additives, for example), a foaming agent or filler, dyes or coloring agents, polymerization catalysts, UV stabilizers, cure accelerators, leveling agents, flexibility additives, and flame retardants, for example.

The luminescent pigment may include, for example, alkaline earth aluminate phosphors, zinc sulfides, such as ZnS:Cu, silicate aluminates, strontium aluminate (SrAlO3:Eu) and combinations thereof. Silicate aluminates are preferred. Various particle amounts, particle sizes, mesh sizes and grades of the pigments may be used depending on the desired effect. Alkaline earth aluminate phosphors and silicate aluminates have longer glow times than ZnS:Cu, for example. The pigment should be added in an amount effective to produce a luminescent effect.

In forming the play equipment or surface, the luminescent pigment and polymer material may be mixed together and directly injection molded, extruded, blow molded or plastisol molded into any desired object. Additives, such as those listed above may also be included. Alternatively, the luminescent pigment and polymer material may be mixed together and formed into pellets, which may later be heated and formed into any desired object.

According to another embodiment, luminescent children's play equipment or safety surfaces are disclosed comprising a polymer material and a luminescent pigment.

The polymer material may include any plastic or rubber material that can be molded or shaped, such as, for example, rubber, styrenics, polyolefin, plastisol, PVC, acrylics, polyurethane, polyacrylates, polycarbonate, polypropylene, polyamides, polymethacylics, polycyanoethylenes, polyacrylonitrides, polyphenylene oxide, polyimide, ethylenevinylchloride, polyvinylacetate, acrylonitrile rubber, melamine, polyethylene, polystyrene, polyesters, and combinations thereof. In addition to the polymer material and luminescent material, the luminescent children's play equipment or safety surface may also include silicone (a releasing agent), mineral oil (to improve injection molding flow and/or adhesion to other additives, for example), a foaming agent or filler, dyes or coloring agents, polymerization catalysts, UV stabilizers, cure accelerators, leveling agents, flexibility additives, and flame retardants, for example.

The luminescent pigment may include, for example, alkaline earth aluminate phosphors, zinc sulfides, such as ZnS:Cu, silicate aluminates, strontium aluminate (SrAlO3:Eu) and combinations thereof. Silicate aluminates are preferred. Various particle amounts, particle sizes, mesh sizes and grades of the pigments may be used depending on the desired effect. The pigment should be added in an, amount effective to produce a luminescent effect.

According to another embodiment of the invention, a play mulch or garden mulch is disclosed comprising a ground polymer material or combination of polymer materials, and a coating applied to the polymer having a luminescent material. This mulch may be used under swing sets or other playground equipment and also may be used in landscaping or garden beds. The mulch may be used to cover the entire area of the garden or playground or may be used only as a border. “Ground” is meant to include any process by which the polymer material may be cut or chopped into pieces. The pieces may be of uniform size and shape or may vary in shape and size. The polymer material may include, for example, rubber, styrenics, polyolefin, plastisol, PVC, acrylics, polyurethane, polyacrylates, polycarbonate, polypropylene, polyamides, polymethacylics, polycyanoethylenes, polyacrylonitrides, polyphenylene oxide, polyimide, ethylenevinylchloride, polyvinylacetate, acrylonitrile rubber, melamine, polyethylene, polystyrene, polyesters, or combinations thereof. The polymer material may additionally include additives, such as colorants or pigments, for example. In a preferred embodiment the ground polymer material is comprised of recycled tires which have been ground into pieces.

The coating may be any medium capable of coating the polymer being employed in the mulch and which can contain a luminescent material. Where the polymer material is comprised of rubber, the coating is preferably comprised of a clear organic resin, and most preferably comprised of a clear epoxy. One of ordinary skill in the art will recognize that the coating employed will preferably have good adhesion or compatibility with the polymer. The coating may additionally include bonding agents. The coating having the luminescent material may be applied to the ground polymer material by spraying, dipping, or mixing, for example.

The luminescent material added to the coating may include, for example, alkaline earth aluminate phosphors, zinc sulfides, such as ZnS:Cu, silicate aluminates, strontium aluminate (SrAlO3:Eu) and combinations thereof. Various particle sizes, mesh sizes and grades of the pigments may be used depending on the desired effect. Sizes ranging from 10-70 um particle size and 200 to 500 mesh size, for example, are preferably employed. The larger the particle size, the higher the intensity of luminescence. Particle sizes of about 45-65 um, 200 mesh, are generally suitable for brush painting and dipping. Particle sizes of about 10-40 um, 300-400 mesh, are generally suitable for spray painting and plastic molding. Glow time and intensity are generally dependent on type of pigment, particle size and grade. Alkaline earth aluminate phosphors and silicate aluminates have longer glow times than ZnS:Cu, for example. The pigment may be added to the media in an amount effective to produce a luminescent effect. Color dyes may also be added to the pigments to achieve various luminescent colors.

According to an alternative embodiment for the play mulch, a first coat of paint is applied to the ground polymer material before the coating having the luminescent material is applied. The paint is preferably a rubber paint (i.e., a paint suited for painting rubber materials) where the polymer is comprised of rubber, such as when the polymer is comprised of ground tires. This first paint coat may be any color, and allows the polymer material to be painted to any desired color, thus enhancing the aesthetic effect of the play mulch or garden mulch.

According to an alternative embodiment, the play mulch or garden mulch may be comprised of ground polymer materials including a luminescent pigment, rather than having a coating containing a luminescent material applied to the ground polymer materials. The polymer materials may include, for example, any of those polymer materials listed above. The luminescent material may include, for example, any of those luminescent materials listed above.

According to another embodiment of the present invention, a luminescent polymer surface, such as a play surface or parking surface is disclosed comprising a polymer surface with a coating having a luminescent material. Such surfaces may be employed, for example, in playgrounds, on tennis, volleyball and basketball courts, around pools, and in parking lots. The polymer surface may be comprised of, for example, rubber, styrenics, polyolefin, plastisol, PVC, acrylics, polyurethane, polyacrylates, polycarbonate, polypropylene, polyamides, polymethacylics, polycyanoethylenes, polyacrylonitrides, polyphenylene oxide, polyimide, ethylenevinylchloride, polyvinylacetate, acrylonitrile rubber, melamine, polyethylene, polystyrene, polyesters, or combinations thereof. Preferably, the polymer surface is comprised of a rubber material. The coating is preferably comprised of a clear organic resin, and most preferably comprised of a clear epoxy. One of ordinary skill in the art will recognize that the coating employed will preferably have good adhesion or compatibility with the polymer. The luminescent material added to the coating may include, for example, alkaline earth aluminate phosphors, zinc sulfides, such as ZnS:Cu, silicate aluminates, strontium aluminate (SrAlO3:Eu) and combinations thereof. The coating may additionally include bonding agents. The coating having the luminescent material may be applied to the polymer surface by spraying or rolling, for example. The coating may be applied directly to the polymer surface or the polymer surface may be painted and the luminescent coating applied to the coating of paint.

According to another aspect of the present invention, luminescent playground equipment is disclosed comprising playground equipment having a coating which includes a luminescent material. The playground equipment may include, for example, jungle gyms, swing sets, teeter-totters, and play structures. The equipment may be made of, for example, plastic, metal, or wood. The coating comprises a luminescent material such as alkaline earth aluminate phosphors, zinc sulfides, such as ZnS:Cu, silicate aluminates, strontium aluminate (SrAlO3:Eu) and combinations thereof. The coating may also include binders or bonding agents and preservatives, for example. Preferably the coating has good adhesion to the material comprising the playground equipment. One exemplary coating comprises a clear epoxy and a luminescent material.

Other applications for luminescent coating:
1) A method of use for a coating comprising a luminescent material comprises applying the coating to a top of a surface material, such as existing concrete, pavers, driveways, sidewalks, and joint material in paving systems. The luminescent coating preferably has good adhesion to the surface material. The coating may additionally contain dyes, pigments or other colorants.
2) A method of use for a coating comprising a luminescent material comprises applying the coating to highway safety vests, road safety barrels, and highway road signs. The luminescent coating preferably has good adhesion to the material being coating.
3) A method of use for a coating comprising a luminescent material comprises applying the coating to vehicle inspection stickers to illuminate number, name of state, and/or month of expiration.
4) A method of use for a coating comprising a luminescent material comprises applying the coating to metal, paper, cardboard, and/or decals to illuminate hazardous or toxic containers, such as toxic waste drums and tankers.
5) A method of use for a coating comprising a luminescent material comprises applying the coating to stone, sand or other mineral aggregates for decorative landscape purposes.

Other applications utilizing luminescent material include: 1) mixing the luminescent material (e.g., in powder form) into plastic or a coating and floating on top of concrete or asphalt prior to the concrete or asphalt being cured (this will lock the glow material in the concrete or asphalt illuminating the walkway, driveway or road surface); 2) mixing the luminescent material into glass (e.g., A-glass) or plexiglass used in doors or windows to prevent accidents at night due to people walking into the doors or windows; 3) placing a polymer material, preferably an acrylic in a fine aggregate form, comprising the luminescent material onto an uncured mortar material for use on pool copings (borders around pools), for example. The polymer material may be floated on the top of the poured, uncured concrete or other mortar material by sprinkling, for example, the polymer material on the uncured mortar material. The luminescent material will cause the concrete surface to illuminate.

According to another embodiment of the present invention, a polymeric joint material for interlocking pavers, such as concrete and clay brick pavers or stone sets, for example, is disclosed comprising pieces of polymer material and a binder. The joint material is placed in the joints between the pavers. The joint material can enhance the appearance of the paver system as well as preventing movement of the individual pavers. While optimally used as a joint material, this material may also be employed as a sub-base underneath pavers, pavement, concrete, and sidewalks, for example, to substantially reduce the weight of the material employed in this application. In current applications, heavy crushed bluestone or sand is employed as a sub-base.

Current paver systems include sand, stone (such as bluestone), or other mineral aggregates between the paver segments which may be loose or bound by adding a glue or binder to keep the joint material in place. The use of sand, stone or other aggregates in these systems has the disadvantage of being very heavy and thus laborious to use. The replacement of lightweight polymers with all or a portion of the sand or stone currently used can substantially reduce the weight of the material and therefore freight costs and also can provide increased options for enhancing the aesthetic appearance of the joint material and overall paver system.

The polymer pieces of one embodiment of the present invention may be comprised of, for example, rubber, plastics, styrenics, polyolefin, plastisol, PVC, acrylics, polyurethane, polyacrylates, polycarbonate, polypropylene, polyamides, poly (ethylene terephthalate), polymethacylics, polycyanoethylenes, polyacrylonitrides, polyphenylene oxide, polyimide, ethylenevinylchloride, polyvinylacetate, acrylonitrile rubber, melamine, polyethylene, polystyrene, polyesters, and/or combinations thereof. These materials, such as the plastics and rubber, may be recycled or non-recycled. One exemplary embodiment includes rubber recycled from tires. Preferably, the polymer has a high tensile strength ranging from about 500-8000 psi. The polymer may be formed into pieces by any process known in the art, such as injection molding, blow molding, milling, chopping, grinding, pelletizing, and the like. For example, the polymer pieces may be formed from a liquid resin made into pellets by any process known to those of ordinary skill in the art. The size of the pieces may vary depending on the application and desired appearance. Such sizes preferably range from a very fine dust to 4 to 8 inches or more. The sizes may be substantially uniform or a blend of various sizes can be employed. For example, finely milled polymer pieces can be mixed with larger round pieces, the smaller pieces being filler. The sizes and shapes may be comparable to presently used sand, bluestone, or other aggregates. In one exemplary embodiment, the polymer pieces are angular in shape like bluestone and of the same size range as bluestone. Preferably, the size and shape of the polymer pieces are such that they can be compacted substantially without voids. The polymer pieces of the present invention have the advantage of being much lighter than sand or stone. Thus, they are much easier to handle and apply, and use of them will substantially reduce freight costs.

The polymer pieces may additionally include dyes, colorants or pigments to create any desired color. The addition of dyes, pigments or other colorants to a polymer material from which the polymer pieces will be formed, has the advantage of providing a material from which the color will not run. This provides an advantage over the mixture of sand and pigments, where color run-off is common. In one preferred embodiment, the polymer pieces also contain a luminescent material such as alkaline earth aluminate phosphors, zinc sulfides, such as ZnS:Cu, silicate aluminates, strontium aluminate (SrAlO3:Eu) and/or combinations thereof. Alternatively, the polymer pieces may be coated with a coating having a luminescent material such as those listed. The coating may be any coating known to those skilled in the art for coating the particular polymer being employed. For example, the coating may be an organic resin such as a clear epoxy when coating rubber or certain plastics. The coating having the luminescent material may be directly applied to the polymer pieces or may be applied to a coating of paint that has been applied to the polymer pieces. In an alternative embodiment, the luminescent material may be mixed, in powder form, for example, with the polymer pieces and binder.

The binder may be any material which is suitable for gluing or bonding the polymer pieces together. In one embodiment, the binder comprises a material which may be applied to the polymer in liquid form, becomes dry and is activated when moisture (such as water) is applied. U.S. Pat. No. 5,686,180 discloses a water activated adhesive and is incorporated by reference herein. Alternatively, the binder may be a material which may be applied to the polymer in liquid form, becomes dry and is activated (or reactivated) when heat is applied. Such materials may include hot-melt adhesives such as those disclosed in U.S. Pat. No. 5,459,184 which is incorporated by reference herein. The application of the hot-melt adhesive may be applied before the polymer is broken into pieces or after the polymer is cut into pieces, however, in the latter case, where the original application of the adhesive to the polymer pieces bonds the polymer pieces together, the polymer aggregate will have to be cut or ground again into pieces again before the pieces are placed into the joints. In an alternative embodiment, the binder is a dry material which can be mixed (e.g., by hand or by a mixing or tumbling machine) into the polymer pieces and subsequently activated with moisture to lock the pieces together. Such a material may include Sandlock®, a powdered organic additive, produced by Pave Tech, Inc. This material is not preferred, however, where the material may come into contact with asphalt, as this material damages the asphalt. Where asphalt may be present, preferably, a binder is employed, such as one of the polymer or prepolymer binders disclosed above which will not be damaging to asphalt. The amount of binder mixed with the polymer pieces will vary depending on particle or piece size. The larger the particle size, the less binder will be required.

The binder may additionally be: 1) a polymer such as that disclosed in U.S. Pat. Nos. 2,867,278, 3,181,611, and 3,181,612; 2) a urethane prepolymer such as that disclosed in U.S. Pat. Nos. 3,719,050, 3,805,531, and 3,805,532; 3) a polyurethane such as that disclosed in U.S. Pat. No. 3,367,892; 4) a vinyl ester resin such as that disclosed in U.S. Pat. No. 3,651,649; 5) a moisture curable NCO-terminated prepolymer such as that disclosed in U.S. Pat. No. 4,139,676; and 6) a urethane composition such as that disclosed in U.S. Pat. Nos. 4,659,748, 5,001,190, and 5,048,608. All above patent references are incorporated by reference herein. Other moisture curable polymers or prepolymers known to those of ordinary skill in the art may also be employed as a binder. Many of the above polymer compositions are especially suited for use with mineral aggregates, such as soil, sand or stone which adhere well to the polymer compositions. Although polymers, such as plastics and rubber, do not have as many reactive sites as mineral aggregates, methods known to those of ordinary skill in the art may be employed to increase the number of reactive sites on the polymer pieces to improve the adhesion to the binder. Such binders may be mixed with the polymer pieces prior to application into the joints or may be applied to the polymer pieces already inserted into the joints.

In one preferred embodiment, the binder comprises Stabilizer®, a natural, organic, non-toxic binder which includes psyillium produced by Stabilizer Solutions Inc. of Phoenix, Ariz. The binder may also comprise the Stabilizer® product in combination with polypropylene fibers, such as those sold under the trademark SportGrids® by Stabilizer Solutions Inc. of Phoenix, Ariz. Alternatively, the binder may comprise other psyillium-based products that act to bind the polymer pieces and/or mineral pieces together. The advantage of using a natural psyillium-based binder includes the fact that it is non-toxic to plants, animals and humans, and unlike the Sandlock product, it is not damaging to asphalt.

In an alternative embodiment, the binder comprises pine pitch and rosin, such as Road Oyl®, a product produced by Soil Stabilization Products Co. of Merced, Calif. Road Oyl® is a liquid binder, the use of which results in a non-porous and slightly loose surface.

The binder may also include one or more catalysts (for faster curing), adhesion promoters, light stabilizers, antioxidants, pigments, and/or dyes. A luminescent powder may also be included into the binder. The binder may also be used in conjunction with a solvent, such as an organic solvent.

In another alternative embodiment, the binder is a chemical which may be added to the polymer pieces which at least partially “melts” the pieces. The pieces become consolidated upon, for example, evaporation of the binder. On example of such a chemical, although less preferred due to toxicity and environmental concerns, is toluene, which may be added to rubber to “melt” the rubber pieces together.

Preferably, once activated, the binder is rigid, but flexible to allow for thermal expansion and contraction. Also, preferably, the binder is non-toxic, colorless and odorless. Preferably the binder is comprised of a material which does not break down from uv light.

In addition to the polymer pieces and binder, the joint material may further include an amount of ball. The inclusion of this material may be a benefit by acting as a spacer, and by adding strength and integrity. Also, the polymeric joint material may include additives such as colorants (e.g., pigments or dyes) and/or adhesion promoters mixed with the binder and polymer pieces.

In another embodiment, the polymeric joint material further includes one or more of sand, stone (including bluestone), and other aggregates. The use of sand, stone or other aggregates can reduce the cost of the joint material, and varying percentages of polymer pieces versus the sand, stone or aggregates may be employed depending on, for example, cost concerns and aesthetics. As an example, polymer pieces and sand may be employed in a 1:1 ratio, reducing the cost, while still substantially reducing the weight over the use of sand alone. This embodiment may further include dyes, colorants or pigments added to the sand, stone or other aggregates. This would allow, for example, the matching of the sand, stone or aggregate color to the color of the polymer pieces.

The benefits of the polymeric joint material of the present invention may include reduced weed growth, substantially reduced weight, increased ant prevention, flexibility and accommodation of thermal movement, prevention of chip out or break apart from wear, ability to work in all climatic conditions, and lack of staining,

A method of making the polymeric joint material described above comprises:
a) forming a polymer material into joint material pieces;
b) blending the polymer pieces with a binder.

A method of consolidating the polymeric joint material described above comprises:
a) blending polymer pieces with a binder to form a polymeric joint material;
b) spreading the polymeric joint material on a surface having joints; and
c) activating the binder to bond together the polymer pieces.

The step of blending can be accomplished either by hand mixing or dry mixing in a mechanical mixer on site, or material can be pre-mixed in proper proportions and delivered to the work site. Preferably, the blended polymer pieces and binder should be kept dry (protected from excessive moisture) prior to use where the binder is moisture activated. The spreading step may include sweeping the material into the paver joints using a broom or other instrument. Preferably the process also includes compacting the polymer pieces using a compactor to reduce the voids. Preferably, the spreading and compacting steps are repeated until the joints are full and no more polymeric joint material can be vibrated into them.

The process preferably also includes sweeping or blowing the entire surface area to clean any residual polymeric joint material remaining on the pavers or other surface material before the binder is activated.

The activating step can be accomplished by adding moisture to the material where a moisture or water-activated binder is used, such as by flooding with water. Where a heat-activated binder is used, heat may be applied to activate the binder and glue the polymer pieces together. An alternative method for consolidating the polymeric joint material comprises:
spreading polymer pieces on a surface having joints, and
adding a binder material to form a bound polymeric joint material.

The adding step may be done through spraying or coating, for example.

According to another embodiment of the present invention, a joint material for interlocking pavers, such as concrete and clay brick pavers or stone sets, for example, is disclosed comprising a mineral material and a plant-based binder. The joint material is placed in the joints between the pavers. The joint material can enhance the appearance of the paver system as well as preventing movement of the individual pavers.

The mineral material may include, for example, sand, stone (e.g., bluestone), other mineral aggregates and/or combinations thereof. According to one embodiment, the binder comprises a psyillium-based material. Preferably, the psyillium binder is Stabilizer® made by Stabilizer Solutions Inc. of Phoenix, Ariz. Stabilizer® is a natural, non-toxic binder which includes psyillium. The binder may also comprise the Stabilizer® product in combination with polypropylene fibers, such as those sold under the trademark SportGrids® by Stabilizer Solutions Inc. According to another embodiment, the plant-based binder may comprise pitch and rosin, such as Road Oyl® produced by Soil Stabilization Products Co. of Merced, Calif. The joint material may additionally include colorants, such as pigments or dyes, to impart a desired color to the joint material. The joint material may further include additives such as adhesion promoters. The joint material may be made and used in accordance with the methods given above for the polymeric joint material.

Other inventions and embodiments:

Polymer (plastic or rubber, but preferably recycled rubber, such as ground mill rubber) added to concrete mixture, replacing stone or sand in concrete. This will substantially lower the weight and increase ability to absorb impact without fracturing, as well as providing noise reduction. Potential applications include roads, driveways and sidewalks, for example.

Polymer (preferably ground mill rubber from recycled rubber) mixed with cinder block mix, preferably replacing the sand in the cinder block mix with the rubber in the formation of cinder block, and preferably additionally also
including a fire retardant. Alternatively the cinder block mix having the polymer included may be used as cinder block fill, i.e., in between cinder blocks.

1. A process for making a luminescent cemetery marker comprising applying a luminescent material to a cemetery marker.

2. The process of claim 1, wherein the luminescent material is non-toxic.

3. The process of claim 1, wherein the luminescent material comprises a coating containing a luminescent pigment.

4. The process of claim 3, wherein the luminescent pigment includes a silicate aluminate.

5. The process of claim 3, wherein the coating comprises a clear epoxy and a bonding agent.

6. The process of claim 1, wherein the luminescent material comprises a glaze.

7. A process for making a luminescent cemetery marker comprising forming a cemetery marker from a polymer material, wherein said polymer material contains a luminescent pigment.

8. The process of claim 7, wherein said luminescent material comprises a silicate aluminate.

9. The process of claim 7, wherein the polymer material is rubber, styrenics, polyolefin, plastisol, PVC, acrylic, polyurethane, polyacrylates, polycarbonate, polypropylene, polyamides, polymethacylics, polycyanoethylenes, polyacrylonitrides, polyphenylene oxide, polyimide, ethylenevinylchloride, polyvinylacetate, acrylonitrile rubber, melamine, polyethylene, polystyrene, polyesters, or a combination thereof.

10. A luminescent cemetery marker comprising a cemetery marker including a luminescent material.

11. The cemetery marker of claim 10, wherein the luminescent material is applied to an outside surface of the cemetery marker.

12. The cemetery marker of claim 10, wherein the cemetery marker is formed of a material including a luminescent pigment.

13. A process for making luminescent children's play equipment comprising forming the play equipment of a composition comprising a polymer material and a luminescent pigment.

14. The process of claim 13, wherein the luminescent pigment is non-toxic.

15. The process of claim 13, wherein the luminescent pigment includes a silicate aluminate.

16. The process of claim 13 wherein the polymer material is rubber, styrenics, polyolefin, plastisol, PVC, acrylic, polyurethane, polyacrylates, polycarbonate, polypropylene, polyamides, polymethacylics, polycyanoethylenes, polyacrylonitrides, polyphenylene oxide, polyimide, ethylenevinylchloride, polyvinylacetate, acrylonitrile rubber, melamine, polyethylene, polystyrene, polyesters, or a combination thereof.

17. A luminescent children's play equipment article comprising a polymer material and a luminescent pigment.

18. The play equipment article of claim 1, wherein the luminescent pigment is a silicate aluminate.

19. A process for making luminescent safety surfaces comprising forming the surface of a composition comprising a polymer material and a luminescent pigment.

20. The process of claim 19, wherein the luminescent pigment is non-toxic.

21. The process of claim 19, wherein the luminescent pigment includes a silicate aluminate.

22. The process of claim 19 wherein the polymer material is rubber, styrenics, polyolefin, plastisol, PVC, acrylic, polyurethane, polyacrylates, polycarbonate, polypropylene, polyamides, polymethacylics, polycyanoethylenes, polyacrylonitrides, polyphenylene oxide, polyimide, ethylenevinylchloride, polyvinylacetate, acrylonitrile rubber, melamine, polyethylene, polystyrene, polyesters, or a combination thereof.

23. A safety surface comprising a polymer material and a luminescent pigment.

24. The safety surface of claim 1, wherein the luminescent pigment is a silicate aluminate.

25. A play mulch or garden mulch comprising:
a polymer ground into pieces; and
a coating applied to the polymer and having a luminescent material.

26. The mulch of claim 25, wherein the polymer is ground-up tires.

27. The mulch of claim 25, wherein the coating comprises a clear epoxy.

28. The mulch of claim 25, wherein the luminescent material includes alkaline earth aluminate phosphors, zinc sulfides, silicate aluminates, strontium aluminate or combinations thereof.

29. A play or garden mulch comprising:
a polymer material ground into pieces;
a paint applied to the polymer; and
a coating applied to the paint and having a luminescent material.

30. The mulch of claim 29, wherein the polymer is ground-up tires, and wherein the paint is a rubber paint, and wherein the coating comprises a clear epoxy.

31. The mulch of claim 29, wherein the paint is colored.

32. A process for making play mulch or garden mulch comprising:
grinding a polymer material into pieces, and
applying a coating having a luminescent material to the ground polymer pieces.

33. The process of claim 32, wherein the coating is applied by spraying.

34. The process of claim 32, wherein the polymer material is comprised of rubber tires.

35. The process of claim 32, wherein the coating comprises a clear resin.

36. The process of claim 32, wherein the luminescent material comprises alkaline earth aluminate phosphors, zinc sulfides, silicate aluminates, strontium aluminate or combinations thereof.

37. A process for making play mulch or garden mulch comprising:
grinding a polymer material into pieces,
applying a paint to the polymer pieces, and
applying a coating having a luminescent material to the painted polymer pieces.

38. The process of claim 36, wherein the polymer is comprised of rubber tires.

39. The process of claim 37, wherein the paint is colored.

40. The process of claim 36, wherein the coating is comprised of a clear epoxy.

41. The process of claim 36, wherein the luminescent material comprises alkaline earth aluminate phosphors, zinc sulfides, silicate aluminates, strontium aluminate or combinations thereof.
